(19) United States
(12) Patent Application Publication
(10) Pub. No.: US 2025/0309359 A1
(43) Pub. Date: Oct. 2, 2025

(54) ALL-SOLID-STATE BATTERY

(71) Applicants: HYUNDAI MOTOR COMPANY, Seoul (KR); Kia Corporation, Seoul (KR)

(72) Inventors: Ju Min KIM, Hwaseong-si (KR); Yoon Seon KIM, Hwaseong-si (KR); Hyun Geun KWON, Hwaseong-si (KR); Tae Young KWON, Hwaseong-si (KR); Yong Hun LEE, Hwaseong-si (KR)

(73) Assignees: HYUNDAI MOTOR COMPANY, Seoul (KR); Kia Corporation, Seoul (KR)

(21) Appl. No.: 18/944,790

(22) Filed: Nov. 12, 2024

(30) Foreign Application Priority Data
Apr. 2, 2024 (KR) 10-2024-0044833

(51) Int. Cl. H01M 10/0585

(52) U.S. Cl. CPC H01M 10/0585

(57) ABSTRACT

An all-solid-state battery including a first electrode includes a first electrode current collector including a first electrode tab protruding to one side in a first direction, a second electrode having an opposite pole to a pole of the first electrode, stacked on the first electrode in a second direction intersecting the first direction, and including a second electrode current collector including a second electrode tab protruding to an opposite side in the first direction, a solid electrolyte provided between the first electrode and the second electrode, and an edge member extending along a circumference of the first electrode, and supporting the solid electrolyte. One end portion of the solid electrolyte, which faces the opposite side in the first direction, protrudes to the opposite side of the edge member in the first direction to support the second electrode tab.

### CROSS-REFERENCE TO RELATED APPLICATION

The present application claims priority to Korean Patent Application No. 10-2024-0044833, filed on Apr. 2, 2024, the entire contents of which is incorporated herein for all purposes by this reference.

### BACKGROUND OF THE PRESENT DISCLOSURE

### Field of the Present Disclosure

The present disclosure relates to an all-solid-state battery.

### Description of Related Art

Unlike primary batteries that cannot be recharged once being discharged, secondary batteries which may be repeatedly charged and discharged may be applied to various fields, such as smartphones, vehicles, drones, and robots, and their importance is increasing day by day.

Because secondary batteries according to a conventional technology use liquid as an electrolyte, there was a problem of poor stability, such as expansion due to temperature changes or leakage due to an external shock, leading to explosion and fire, and to solve these problems, research and development on all-solid-state batteries is being actively conducted.

All-solid-state batteries have high structural stability because an electrolyte located between a positive electrode active material and a negative electrode active material is formed of solid, and thus, there may be no need to provide a separator. Due to the provided configuration, the battery may become smaller and include a high energy density. However, in the case of an all-solid-state battery, the electrode active materials may be expanded or contracted during charging/discharging, and as a result, interfaces between the electrode active materials and the solid electrolyte are separated and performance is degraded.

To achieve this, to prevent delamination of the interfaces between the electrode active materials and the solid electrolyte, a warm isostatic press process of the all-solid-state battery may be performed, and accordingly, a demand for a structure for preventing damage to an electrode tab of an electrode current collector during the warm isostatic pressing is increasing.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an all-solid-state battery which may prevent damage to an electrode tab during warm isostatic pressing.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an all-solid-state battery includes a first electrode including a first electrode current collector including a first electrode tab protruding to one side in a first direction, a second electrode having an opposite pole to a pole of the first electrode, stacked on the first electrode in a second direction intersecting the first direction, and including a second electrode current collector including a second electrode tab protruding to an opposite side in the first direction, a solid electrolyte provided between the first electrode and the second electrode, and an edge member extending along a circumference of the first electrode, and supporting the solid electrolyte, and one end portion of the solid electrolyte, which faces the opposite side in the first direction, protrudes to the opposite side of the edge member in the first direction to support the second electrode tab.

The opposite end portion of the solid electrolyte, which faces the one side in the first direction, may protrude to one side of the first electrode in the first direction to support the first electrode tab.

The edge member may include an edge hole formed on one side of the first electrode in the first direction, and the opposite end portion of the solid electrolyte, which faces to one side in the first direction, may be located in the edge hole.

The second electrode may further include a second electrode active material formed in the second electrode current collector, the first electrode may further include a first electrode active material formed in the first electrode current collector, and an area of the second electrode active material, which is formed in the second electrode current collector, may be configured to be greater than an area of the first electrode active material, which is formed in the first electrode current collector.

One end portion of the second electrode active material, which faces the opposite end portion in the first direction, may be configured to correspond to the one end portion of the solid electrolyte.

The opposite end portion of the solid electrolyte, which faces the one side in the first direction, may protrude to the one side of the first electrode active material in the first direction.

The edge member may support the second electrode active material which is formed on the second electrode current collector disposed at an external side of the first electrode active material formed on the first electrode current collector, at an outside of the first electrode.

A length (L), by which the one end portion of the solid electrolyte protrudes to the opposite side of the edge member in the first direction, is equal to or greater than 1.5 times a height (H) of the edge member in the second direction.

A distance (D), by which the opposite end portion of the solid electrolyte protrudes to one side of the first electrode in the first direction, may be configured to be equal to or greater than 1.5 times a height difference (G) of the opposite end portion of the solid electrolyte and the second electrode current collector in the second direction.

A pair of second electrodes may be provided to extend in parallel to each other while the first electrode being interposed therebetween, a pair of solid electrolytes may be provided to be disposed between the pair of second electrodes and the first electrode, respectively, and the edge member may be disposed between the pair of solid electrolytes.

The first electrode may include a positive electrode, and the second electrode may include a negative electrode.

The solid electrolytes may be coated on the second active material of each of the pair of second electrodes.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a plan view of an all-solid-state battery according to an exemplary embodiment of the present disclosure;

FIG. 2 is a plan view of a first electrode, a pair of second electrodes, and an edge member of an all-solid-state battery according to an exemplary embodiment of the present disclosure;

FIG. 3 is a plan view of any one of a pair of second electrodes, on which a first electrode and an edge member of an all-solid-state battery are stacked, and the other of the pair of second electrodes according to an exemplary embodiment of the present disclosure;

FIG. 4 is a longitudinal cross-sectional view of a portion of one side of an all-solid-state battery in a first direction according to an exemplary embodiment of the present disclosure.

FIG. 5 is a longitudinal cross-sectional view of a portion of an opposite side of an all-solid-state battery in a first direction according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted.

Furthermore, in describing the components of the exemplary embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms include the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in an exemplary embodiment of the present disclosure.

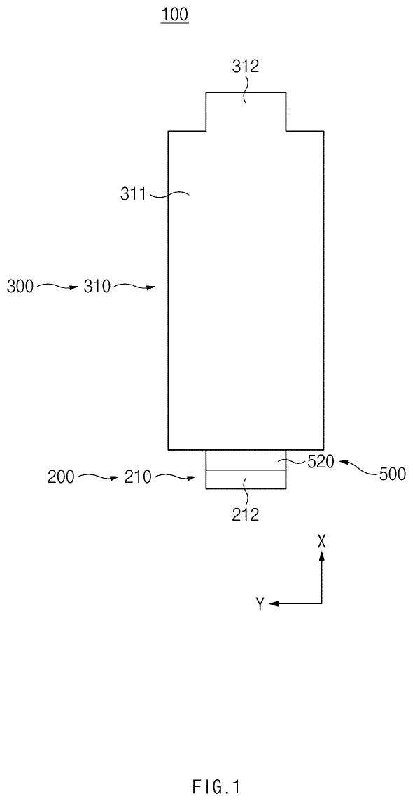

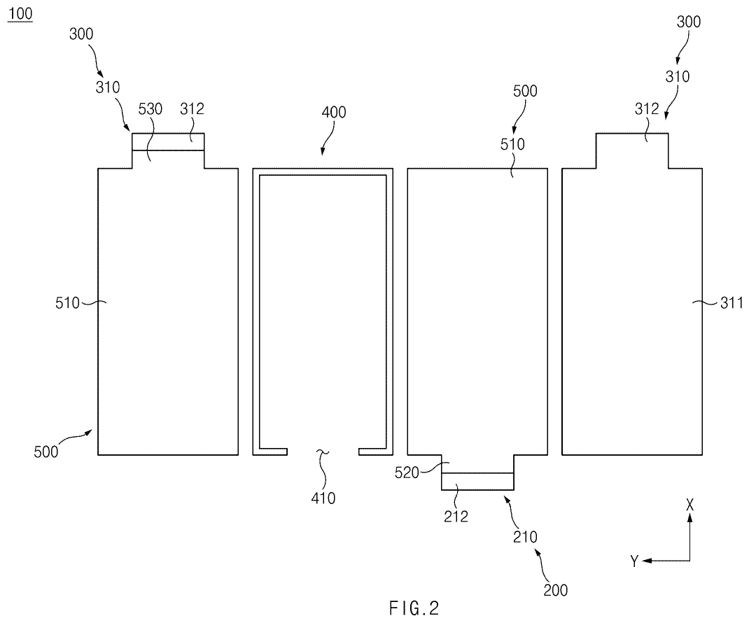

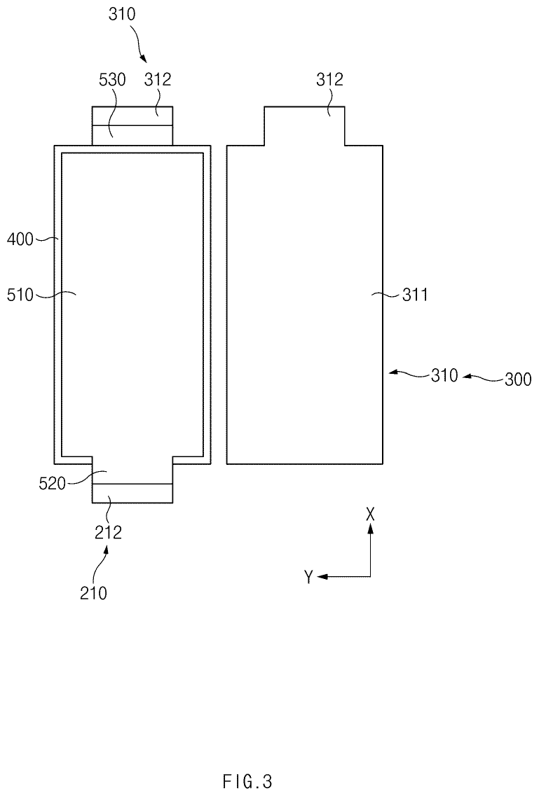

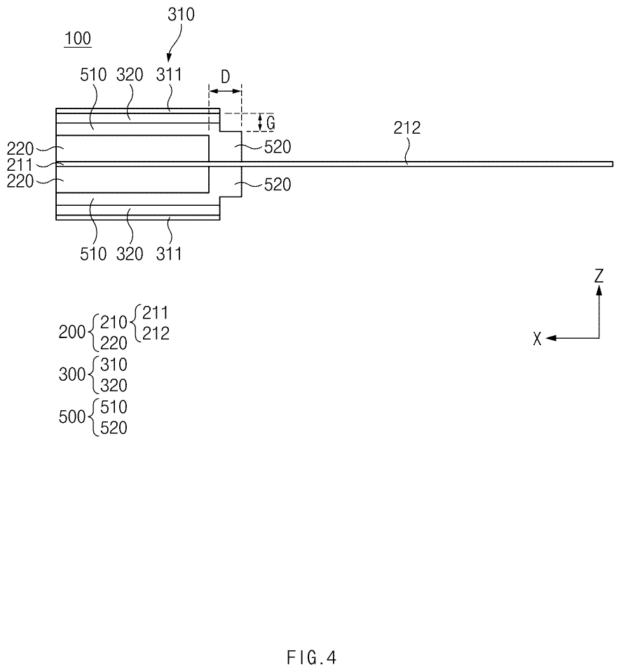

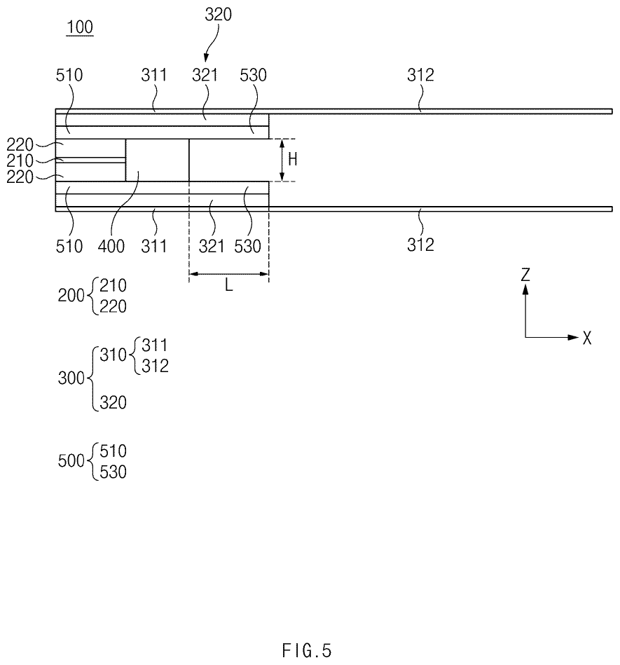

Hereinafter, various exemplary embodiments of the present disclosure will be described in detail with reference to FIG. 1, FIG. 2, FIG. 3, FIG. 4, and FIG. 5.

FIG. 1 is a plan view of an all-solid-state battery according to an exemplary embodiment of the present disclosure. FIG. 2 is a plan view of a first electrode, a pair of second electrodes, and an edge member of the all-solid-state battery according to an exemplary embodiment of the present disclosure. FIG. 3 is a plan view of any one of the pair of second electrodes, on which the first electrode and the edge member of the all-solid-state battery are stacked, and the other of the pair of second electrodes according to an exemplary embodiment of the present disclosure. FIG. 4 is a longitudinal cross-sectional view of a portion of one side of the all-solid-state battery in a first direction according to an exemplary embodiment of the present disclosure. FIG. 5 is a longitudinal cross-sectional view of a portion of an opposite side of the all-solid-state battery in the first direction according to an exemplary embodiment of the present disclosure.

Referring to FIGS. 1 to 5, an all-solid-state battery 100 may include a first electrode 200, and a second electrode 300 which is stacked on the first electrode 200 and includes an opposite pole to a pole of the first electrode 200. The first electrode 200 may be a positive electrode, and the second electrode 300 may be a negative electrode.

In the all-solid-state battery 100, first electrodes 200 and second electrodes 300 may be alternately stacked. The all-solid-state battery 100 according to an exemplary embodiment of the present disclosure may include a bi-cell which is provided with a pair of first electrodes 200 and a second electrodes 300 or a pair of second electrodes 300 and a first electrodes 200. The all-solid-state battery 100 illustrated in FIG. 1, FIG. 2, FIG. 3, FIG. 4, and FIG. 5 may be understood as being provided with a pair of second electrodes 300 and a first electrodes 200.

The first electrode 200 may include a first electrode current collector 210, and a first electrode active material 220 which is formed in the first electrode current collector 210. The second electrode 300 may include a second electrode current collector 310, and a second electrode active material 320 formed in the second electrode current collector 310.

The first electrode current collector 210 may be formed of aluminum (Al), but the present disclosure is not limited thereto. Furthermore, the second electrode current collector 310 may be formed of nickel (Ni), but the present disclosure is not limited thereto.

The first electrode current collector 210 may include a first electrode body 211, and a first electrode tab 212 that protrudes from the first electrode body 211 to one side in the first direction (an opposite direction to the “X” direction). The second electrode current collector 310 may include a second electrode body 311, and a second electrode tab 312 that protrudes from the second electrode body 311 to an opposite side in the first direction (the “X” direction).

The first electrode body 211 of the first electrode current collector 210 may be a portion which is coated with the first electrode active material 220. Likewise, the second electrode body 311 of the second electrode current collector 310 may be a portion which is coated with the second electrode active material 320.

Meanwhile, the all-solid-state battery 100, unlike a lithium ion battery, may include a solid electrolyte 500 in a solid state without a separate separator between the first electrode 200 and the second electrode 300. The all-solid-state battery 100 may be manufactured through a process of coating or transferring the solid electrolyte 500 to one surface of the second electrode 300, which faces the first electrode 200.

Unlike a lithium ion battery, because the particles of the solid electrolyte 500 of the all-solid-state battery 100 include solid particles, it is necessary to form an interface between the solid electrolyte 500 and the first electrode 200 or the solid electrolyte 500 and the second electrode 300. For the present purpose, the all-solid-state battery 100 may require a warm isostatic press (WIP) process.

Accordingly, when the warm isostatic press process is performed on the all-solid-state battery 100, the first electrode tab 212 and the second electrode tab 312, which protrude from opposite sides of the all-solid-state battery 100 in the first direction, may be damaged. The all-solid-state battery 100 according to an exemplary embodiment of the present disclosure may include a structure for preventing damage to the first electrode tab 212 and the second electrode tab 312. Hereinafter, it will be described that the all-solid-state battery 100 includes a first electrode 200, and a pair of second electrodes 300 that face each other with the first electrode 200 being interposed therebetween. However, the present disclosure is not limited to thereto, and may include a second electrode 300 and a pair of first electrodes 200 that face each other with the second electrode 300 being interposed therebetween.

The second electrode 300 may be stacked on the first electrode 200 in a second direction which is perpendicular to the first direction (the “Z” direction or an opposite direction to the “Z” direction). In more detail, the all-solid-state battery 100 may include a pair of second electrodes 300 that are stacked on one side (the “Z” direction) of the first electrode 200 in the second direction and an opposite side (an opposite direction to the “Z” direction) of the first electrode 200 in the second direction with the first electrode 200 being interposed therebetween.

An area of the first electrode active material 220, which is formed in the first electrode current collector 210, may be smaller than an area of the second electrode active material 320, which is formed in the second electrode current collector 310. This is because as the all-solid-state battery 100 is repeatedly charged and discharged, dendrites, which are a phenomenon, in which lithium crystals are formed and are accumulated as nuclei on a surface of the second electrode 300, occurs, a short-circuit occurs between the first electrode 200 and the second electrode 300.

To prevent this, an area, in which the second electrode active material 320 is formed in the second electrode current collector 310, may be configured to be greater than an area, in which the first electrode active material 220 is formed in the first electrode current collector 210. In other words, the second electrode body 311 of the second electrode current collector 310 may be configured to be greater than the first electrode body 211 of the first electrode current collector 210.

The all-solid-state battery 100 may include an edge member 400 that extends along a circumference of the first electrode 200. The edge member 400 may be formed to support a second electrode active material 320 which is formed in the second electrode current collector 310 disposed on an external side of the first electrode active material 220 formed in the first electrode current collector 210, on an outside of the first electrode 200. The edge member 400 may be formed of polyethylene terephthalate (PET), but the present disclosure is not limited thereto.

The edge member 400 may include an edge hole 410 which is formed on one side in the first direction. The first electrode tab 212 of the first electrode 200, and an opposite end portion 520 of the solid electrolyte 500 which is formed on a partial area of the first electrode tab 212, which faces on side in the first direction, may be located in the edge hole 410.

The edge hole 410 may mean an area which is configured to be an open portion of a part formed on one side of the edge member 400 in the first direction, which corresponds to a width of the first electrode tab 212 in a third direction (the “Y” direction or an opposite direction to the “Y” direction) which is perpendicular to the first direction and the second direction.

The solid electrolyte 500 may be coated on the second electrode active material 320 of each of the pair of second electrodes 300. A pair of solid electrolytes 500 may be stacked to face each other, and the edge member 400 and the first electrode 200 may be provided between the pair of solid electrolytes 500.

Accordingly, the first electrode 200 may be configured to be inserted into the edge member 400. The first electrode 200 and the edge member 400 may be stacked on one side of the second electrode 300 in the second direction, which is coated with solid electrolyte 500.

In the present way, as illustrated in FIG. 4 and FIG. 5, the first electrode 200, the solid electrolyte 500, and the edge member 400 may be provided between the pair of second electrodes 300.

That is, the pair of second electrodes 300 may extend in parallel to each other with the first electrode 200 being interposed therebetween, and the pair of solid electrolytes 500 may be disposed between the pair of second electrodes 300 and the first electrode 200, respectively. Accordingly, the edge member 400 may be disposed between the pair of solid electrolytes 500.

The edge member 400 may support the solid electrolyte 500 on the remaining areas, except for the edge hole 410 that includes an open shape on one side (an opposite direction to the “X” direction) in the first direction.

As illustrated in FIG. 4, the first electrode tab 212 of the first electrode 200 may protrude to one side (an opposite direction to the “X” direction) in the first direction, and as illustrated in FIG. 5, the second electrode tab 312 of the second electrode 300 may protrude in an opposite side (the “X” direction) in the first direction.

To prevent the first electrode tab 212 and the second electrode tab 312 from being damaged during the warm isostatic press process, the solid electrolyte 500 may include one end portion 530 that faces an opposite side in the first direction and an opposite end portion 520 that faces one side in the first direction.

In more detail, the solid electrolyte 500 may include an electrolyte body 510 which is coated on the second electrode 300, the one end portion 530 that faces an opposite side (the “X” direction) in the first direction from the electrolyte body 510, and the opposite end portion 520 that faces one side (an opposite direction to the “X” direction) in the first direction from the electrolyte body 510. Here, the electrolyte body 510 may be an area of the solid electrolyte 500, which overlaps the first electrode 200 or the edge member 400.

The opposite end portion 520 of the solid electrolyte 500 may protrude to one side of the first electrode 200 in the first direction. The opposite end portion 520 of the solid electrolyte 500 may protrude further than the first electrode 200 to one side in the first direction and support the first electrode tab 212. Accordingly, the opposite end portion 520 of the solid electrolyte 500 may protrude to one side of the second electrode active material 320 in the first direction.

A distance “D”, by which the opposite end portion 520 of the solid electrolyte 500 protrudes to one side of the first electrode 200 in the first direction, may be greater than or equal to 1.5 times a height difference “G” between the opposite end portion 520 of the solid electrolyte 500 and the second electrode current collector 310 in the second direction.

When the distance “D”, by which the opposite end portion 520 of the solid electrolyte 500 protrudes to one side of the first electrode 200 in the first direction, is less than 1.5 times the height difference “G” between the opposite end portion 520 of the solid electrolyte 500 and the second electrode current collector 310 in the second direction, the first electrode tab 212 is not sufficiently supported when the warm isostatic press process is performed on the all-solid-state battery 100, and thus, the first electrode tab 212 may be damaged. A more detailed description will be made with reference to Table 1 below.

TABLE 1
<Defect rate according to relationship between
“G” and “D” of all-solid-state battery
according to an exemplary embodiment of the present disclosure>

| | Relationship | | Number of | |
|---|---|---|---|---|
| | between “G” and | Number of bi- | defective | Defect |
| Type | “D” | cells | cells | rate |
| The present | “G” = 80 um, | 20 | 0 | 0% |
| disclosure | “D” = 120 um | | | |
| Comparative | “G” = 80 um, | 20 | 16 | 80% |
| example 1 | “D” = 110 um | | | |
| Comparative | “G” = 80 um | 20 | 20 | 100% |
| example 2 | “D” = 80 um | | | |

Referring to Table 1, it may be identified that, among twenty all-solid-state batteries 100, in which “G” is 80 um and “D” is 120 um, which is “D” corresponds to 1.5 times “G”, the number of the all-solid-state battery 100, of which the first electrode tab 212 is damaged after the warm isostatic press process is 0, and thus, the defect rate is 0%.

On the other hand, in comparative example 1, in which “G” is 80 um and “D” is 110 um, that is, “D” corresponds to 1.375 times “G”, and comparative example 2, in which “G” is 80 um and “D” is 80 um, that is, “D” corresponds to 1 times “G”, the numbers of, among twenty all-solid-state batteries 100, the all-solid-state batteries 100, in which the first electrode tab 212 is damaged after the warm isostatic press process are 16 and 20, respectively, and thus the defect rates of comparative examples 1 and 2 are 80% and 100%, respectively.

Through this, when the distance “D”, by which the opposite end portion 520 of the solid electrolyte 500 according to the exemplary embodiment of the present disclosure protrudes to one side of the first electrode 200 in the first direction, is greater than or equal to 1.5 times the height difference “G” between the opposite end portion 520 of the solid electrolyte 500 and the second electrode current collector 310 in the second direction, an effect of preventing damage to the first electrode tab 212 may be achieved, and thus, a productivity of the all-solid-state battery 100 may be improved.

Furthermore, according to the structure, in which the distance “D”, by which the opposite end portion 520 of the solid electrolyte 500 protrudes to one side of the first electrode 200 in the first direction, is greater than or equal to 1.5 times the height difference “G” between the opposite end portion 520 of the solid electrolyte 500 and the second electrode current collector 310 in the second direction, it is possible to prevent a short circuit which may occur between the second electrode current collector 310 and the first electrode current collector 210 even through the warm isostatic press process is applied to the all-solid-state battery 100.

One end portion 530 of the solid electrolyte 500 may protrude to an opposite side of the edge member 400 in the first direction. Accordingly, one end portion 321 of the second electrode active material 320 that faces an opposite side in the first direction may be configured to correspond to one end portion 530 of the solid electrolyte 500.

In more detail, a length “L”, by which the second electrode active material 320 protrudes to an opposite side of the edge member 400 in the first direction may correspond to a length “L”, by which the solid electrolyte 500 protrudes to an opposite side of the edge member 400 in the first direction.

According to the present structure, the one end portion 530 of the solid electrolyte 500 and the one end portion 321 of the second electrode active material 320 may support a partial area of the second electrode tab 312. The one end portion 321 of the second electrode active material 320 may protrude to an opposite side of the edge member 400 in the first direction and support the second electrode tab 312, and the one end portion 530 of the solid electrolyte 500 may protrude to an opposite side of the edge member 400 in the first direction and support the one end portion 321 of the second electrode active material 320 and the second electrode tab 312.

The length “L”, by which the one end portion 321 of the second electrode active material 320 and the one end portion 530 of the solid electrolyte 500 protrude to an opposite side of the edge member 400 in the first direction, may be configured to be greater than or equal to 1.5 times the height “H” of the edge member 400 in the second direction.

When the length “L”, by which the one end portion 321 of the second electrode active material 320 and the one end portion 530 of the solid electrolyte 500 protrudes from an opposite side of the edge member 400 in the first direction is less than 1.5 times the height “H” of the edge member 400 in the second direction, the second electrode tab 312 may be damaged because the second electrode tab 312 is not sufficiently supported when the warm isostatic press process is performed on the all-solid-state battery 100. A more detailed description will be made with reference to Table 2 below.

TABLE 2
<Defect rate according to relationship between
“L” and “H” of all-solid-state battery
according to an exemplary embodiment of the present disclosure>

| | Relationship | | Number of | |
|---|---|---|---|---|
| | between “H” and | Number of bi- | defective | Defect |
| Type | “L” | cells | cells | rate |
| The present | “H” = 100 um, | 20 | 0 | 0% |
| disclosure | “L” = 150 um | | | |
| Comparative | “H” = 100 um, | 20 | 12 | 60% |
| example 1 | “L” = 140 um | | | |
| Comparative | “H” = 100 um | 20 | 20 | 100% |
| example 2 | “L” = 100 um | | | |

Referring to Table 2, it may be identified that, among twenty all-solid-state batteries 100, in which “H” is 100 um and “L” is 150 um, which is “L” corresponds to 1.5 times “H”, the number of the all-solid-state battery 100, of which the second electrode tab 312 is damaged after the warm isostatic press process is 0, and thus, the defect rate is 0%.

On the other hand, in comparative example 1, in which “H” is 100 um and “L” is 140 um, that is, “L” corresponds to 1.4 times “H”, and comparative example 2, in which “H” is 100 um and “L” is 100 um, that is, “L” corresponds to “H”, the number of, among twenty all-solid-state batteries 100, the all-solid-state batteries 100, in which the second electrode tab 212 is damaged after the warm isostatic press process, are 16 and 20, respectively, and thus the defect rates of comparative examples 1 and 2 are 60% and 100%, respectively.

Through this, when the length “L” by which the one end portion 321 of the second electrode active material 320 of the all-solid-state battery 100 according to the exemplary embodiment of the present disclosure and the one end portion 530 of the solid electrolyte 500 protrude to an opposite side of the edge member 400 in the first direction, is greater than or equal to 1.5 times the height “H” of the edge member 400 in the second direction, an effect of preventing damage to the first electrode tab 312 may be achieved, and thus a productivity of the all-solid-state battery 100 may be improved.

By the above-described structure, in the all-solid-state battery 100 according to the exemplary embodiment of the present disclosure, on the warm isostatic press process of the bi-cell including the first electrode 200 and the pair of second electrodes 300 that extend in parallel to each other with the first electrode 200 being interposed therebetween, damage to the first electrode tab 212 and the second electrode tab 312 may be prevented, and thus, the productivity of the all-solid-state battery 100 may be improved.

Furthermore, in the all-solid-state battery 100 according to the exemplary embodiment of the present disclosure, compared to a structure with a separate tab protecting member for protecting the first and second electrode tabs 212 and 312, a process of attaching and removing the tab protecting member may be omitted, and thus a process time for all-solid-state battery 100 may be shortened.

However, the present disclosure is not limited thereto, and for a description of the all-solid-state battery, the above-described structure on the structure of the bi-cell including the second electrode 300, and the pair of first electrodes 200 that extend in parallel to each other with the second electrode 300 being interposed therebetween is used.

In the present technology, when the warm isostatic press process is performed on the all-solid-state battery, the electrode tab of the electrode current collector may be supported by the solid electrolyte, and thus, damage to the electrode tab may be prevented and the productivity of the all-solid-state battery may be improved.

Furthermore, various effects which may be directly or indirectly identified through the present specification may be provided.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An all-solid-state battery comprising:
a first electrode including a first electrode current collector including a first electrode tab protruding to one side in a first direction;
a second electrode having an opposite pole to a pole of the first electrode, stacked on the first electrode in a second direction intersecting the first direction, and including a second electrode current collector including a second electrode tab protruding to an opposite side in the first direction;
a solid electrolyte provided between the first electrode and the second electrode; and
an edge member extending along a circumference of the first electrode, and supporting the solid electrolyte,
wherein one end portion of the solid electrolyte, which faces the opposite side in the first direction, protrudes to the opposite side of the edge member in the first direction to support the second electrode tab.

2. The all-solid-state battery of claim 1, wherein the opposite end portion of the solid electrolyte, which faces the one side in the first direction, protrudes to one side of the first electrode in the first direction to support the first electrode tab.

3. The all-solid-state battery of claim 1,
wherein the edge member includes an edge hole formed on the one side of the first electrode in the first direction, and
wherein the opposite end portion of the solid electrolyte, which faces to the one side in the first direction, is located in the edge hole.

4. The all-solid-state battery of claim 1,
wherein the first electrode further includes a first electrode active material formed in the first electrode current collector, and
wherein the second electrode further includes a second electrode active material formed in the second electrode current collector,
wherein an area of the second electrode active material, which is formed in the second electrode current collector, is greater than an area of the first electrode active material, which is formed in the first electrode current collector.

5. The all-solid-state battery of claim 4, wherein one end portion of the second electrode active material, which faces the opposite end portion in the first direction, corresponds to the one end portion of the solid electrolyte.

6. The all-solid-state battery of claim 4, wherein the opposite end portion of the solid electrolyte, which faces the one side in the first direction, protrudes to the one side of the first electrode active material in the first direction.

7. The all-solid-state battery of claim 4, wherein the edge member supports the second electrode active material which is formed on the second electrode current collector disposed at an external side of the first electrode active material formed on the first electrode current collector, at an outside of the first electrode.

8. The all-solid-state battery of claim 1, wherein a length (L), by which the one end portion of the solid electrolyte protrudes to the opposite side of the edge member in the first direction, is equal to or greater than 1.5 times a height (H) of the edge member in the second direction.

9. The all-solid-state battery of claim 2, wherein a length (D), by which the opposite end portion of the solid electrolyte protrudes to the one side of the first electrode in the first direction, is equal to or greater than 1.5 times a height difference (G) of the opposite end portion of the solid electrolyte and the second electrode current collector in the second direction.

10. The all-solid-state battery of claim 1,
wherein the second electrode is in pair and the pair of second electrodes are provided to extend in parallel to each other while the first electrode being interposed between the pair of second electrodes,
wherein a pair of solid electrolytes are provided to be disposed between the pair of second electrodes and the first electrode, respectively, and
wherein the edge member is disposed between the pair of solid electrolytes.

11. The all-solid-state battery of claim 10, wherein the solid electrolytes are coated on the second electrode active material of each of the pair of second electrodes.

12. The all-solid-state battery of claim 1,
wherein the first electrode includes a positive electrode, and
wherein the second electrode includes a negative electrode.
